(19) United States
(12) Patent Application Publication
(10) Pub. No.: US 2015/0363007 A1
(43) Pub. Date: Dec. 17, 2015

(54) DATA INPUT SYSTEMS FOR HANDHELD DEVICES

(71) Applicant: OCTODON LLC, Ekaterinburg (RU)

(72) Inventor: Alexey LYSENKO, Ekaterinburg (RU)

(21) Appl. No.: 14/761,927

(22) PCT Filed: Jan. 17, 2014
(86) PCT No.: PCT/IB2014/000645

§ 371 Date: Jul. 17, 2015

Related U.S. Application Data
(60) Provisional application No. 61/753,618, filed on Jan. 17, 2013.

(51) Int. Cl. G06F 3/023; G06F 3/041

(52) U.S. Cl. CPC G06F 3/0233; G06F 3/0414

(57) ABSTRACT

Apparatuses, systems, methods and devices for input of data or text into portable electronic devices. Designs and methods are described to position multipositional text and data input elements on the backside and the frontside of the device or on the backside and the frontside of a protective case for the device. Multipositional text and data input elements are described that are positioned to provide for convenient and rapid backtyping, while not significantly increasing the overall thickness of the device and the case. Designs and methods are described to transfer data resulting from activation of input elements to portable electronic devices. Designs and methods of use of multipositional text and data input systems designed for portable electronic devices with a capacitive touch panel.

### CROSS-REFERENCE TO RELATED APPLICATIONS

This application claims priority to U.S. Provisional Application No. 61/753,618, filed Jan. 17, 2013, the entire contents of which are incorporated herein by reference.

### TECHNICAL FIELD

This disclosure relates to the technical field of apparatuses, systems, methods and devices for input of data or text into portable electronic devices.

### BACKGROUND

One of the problems facing users of portable electronic devices is a problem of effective work with character data, and in particular, the problem of effective typing and editing of text, due to the fact that the sizes of portable electronic devices are generally too small to provide them with a suitable QWERTY keyboard which is ergonomically comparable to a full-size keyboard. One of the promising directions in the development of new input devices for portable electronic devices is an approach in which some of the data or text input elements are located on the backside of the unit (facing away from the user during the text typing) for backtyping. The user accesses these elements with his or her index, long, ring and/or little fingers. However, the inability to see the fingers while typing may cause a discomfort for some users. This discomfort may be minimized by displaying helpful typing or device usage hints on the screen of the device. Some backtyping devices also have input elements for thumbs located on the front of the device. This approach allows the user to use all ten fingers in the text or data entering process, and increases the speed and ease of entering.

Large side handles are sometimes used in backtyping portable electronic devices to allo w the user to comfortably hold the device. If the device has a screen, that screen should be clearly visible during text typing. The screen should be located in a plane which is slightly deviated from the user, to provide the user with a comfortable hand position while the user is holding the device by the side handles, and to provide the user with a comfortable visual angle of the screen, which should be close to perpendicular. These two factors lead to the fact that existing electronic devices with side handles are not too compact. For example, Alpha-Ui is a fairly massive cradle for a 5-inch tablet, and significantly increases its size. Grippity and AlphaGrip devices are both similar to game pads and are also quite large.

Thus, incorporating side handles into the design of compact handheld portable electronic backtyping devices involves significant difficulties. Size of the large side handles must be compatible with the size of a modern compact portable electronic device. One solution is to employ a transformation of the device's body to change it from a “pocket” mode into an “operating” mode, but such a transformation can make the device significantly more complex. For example, in the “pocket” mode the device may look like a thin parallelepiped with a screen on the front of the device. In the “operating” mode, side handles would be extended on the sides of the device, and the screen would be slightly turned from the user. A number of input elements to be used by the user's fingers would be located on the backside of the device. These elements must have convenient sizes matching the size of human fingers so that a user may press them without visual contact. The device must be constructed from materials strong enough to withstand the compression of the device by the palms of the user. Thus, the implementation of a “transformation” device design may substantially increase the complexity and the cost of the device.

An alternative design is a “book” grip design of the unit. In this case, a flat device without side handles,] with the input elements located on the backside of the device, is held with both hands in the way a person holds a book or a tablet device while reading from it. This design allows the user to keep a fairly flat device at an angle, which makes it convenient to view the screen. However, because the user's fingers are used to hold the device, their mobility is limited. In this design, part of the weight of the device falls on the first phalanx of the index finger, and the fingers are bent, so the area within which the user's fingers can move on the backside of the device is much smaller than in the “side handles” design described above. In order to increase the number of text or data entries in a device with a “book” grip design under conditions of low finger mobility, multipositional text and data input elements may be used. In such a design, each finger is associated with a multipositional input element usually located on the back side of the device. The finger can displace the input element in different directions to enter test or data. The size of portable device may be increased so that a user can hold the device with both hands.

In the development of backtyping portable electronic devices with multipositional text and data input elements located on the backside of the device, special attention should be paid to ergonomics of the unit and the location of the input elements on the backside of the device. This is because the user's hands simultaneously perform two functions (holding the device and entering the data), and therefore the mobility of fingers is reduced in comparison with data entry on a regular keyboard located on a fixed plane, where the user's hands only perform the function of data entry. Because of limited mobility of the fingers, the input elements must be designed and located with due consideration given to all possible movements of the fingers, so that each finger may comfortably perform several different actions with one or more input elements located on the backside of the unit. A reliable, miniature and easy to manufacture multipositional text and data input element is necessary for achieving a high typing speed. An input element must have such characteristics as short stroke, soft triggering, low rattle effect of the contacts, good tactile feedback and low percentage of false triggering. It must be sensitive enough to respond to the movement of comparably inactive fingers such as ring and little finger. To make the work more comfortable for the user, a multipositional input element must be capable of being manipulated in several different directions. Adding multipositional input elements to the device will increase the thickness of the device more than, for example, simply adding a standard flat mini-keyboard facing the user. The size of the device determines its usability and attractiveness in everyday life, so it is important to minimize the increase of the size of the device because increasing the size of the device in general, and increasing the thickness of device in particular, reduces the attractiveness of the device to the users.

One of the problems specific to portable electronic devices in general, and to the backtyping portable electronic devices in particular, is the problem of arranging the locations of the input elements on the backside of the device so as to allow people with different sized hands to work comfortably with the device. In case of a device with an ordinary keyboard, one possible solution to this problem is to make the keyboard keys large enough for all users. The position of hands over the keyboard and wrist mobility allows people with different sized hands and fingers to type quickly on a keyboard. However, in case of backtyping portable electronic devices, the wrists and palms of the user are mainly used for holding the device, and as a result the mobility of wrists and palms is reduced to almost zero. Therefore, an appropriate location of the input elements for each finger is mainly determined by the length and mobility of the user's fingers. An input element or a keyboard key that is convenient for someone with large palms or longer fingers may cause discomfort for a person with smaller palms or shorter fingers, and vice versa. Positioning of the fingers on the input elements will feel unnatural if the size of the elements does not match the size of the user's hand. Development of a device that provides maximum speed and comfort requires a solution for this problem. One possible solution is to transfer the holding function from the user's fingers to the user's palms. In this case, the palms of the user motionlessly envelop the ergonomic side handles of the device to hold the device. The fingers keep the mobility of all their joints, which in turn allows them to reach several input elements due to bending and unbending, like a finger movement of an accordionist. The examples of backtyping-keyboards that use the principle of providing finger mobility are AlphaGrip, Grittipy, and Alpha-Ui.

In pocket devices, when the user enters the symbols with an attachable keyboard, there is a problem of connecting the keyboard to the device. The keyboard can be connected to a portable device by wires (e.g., through a USB connector or a serial port of the device) or using the wireless interface (such as Bluetooth). The functioning of such solutions requires hardware and software to ensure the appropriate method of communication. In the case of a wireless keyboard connection, a battery in the external keyboard or joystick is required. In the case of wired keyboard connection, an available connection means such as a USB port is necessary to connect the keyboard to the device. Some portable devices may lack a USB port. Also, when connecting by wires, a conflict of using the connector comes up—the target portable device often has only one connector, which is used for PC-connection, charging, or for connecting of accessories. Thus, the simultaneous use of an attachable wired keyboard may be in conflict with the proposed scenario of using of the device. For devices with touch screen, a possible solution is to use a capacitive touch panels. Modern capacitive touch panels used in tablet computers and smartphones are able to recognize a large number of touches both accurately and quickly, that allows the user to control the device using intuitive gestures, consisting of several simultaneous touches. A weakness of the devices that mainly use sensory input elements is the lack of tactile connection with the input elements, which makes it difficult to use such devices in number of tasks, such as the fast text input.

### SUMMARY OF THE INVENTION

This disclosure relates to apparatuses, systems, methods and devices for input of data or text into portable electronic devices. Embodiments described in this disclosure allow ergonomic integration and use of multipositional text and data input elements with portable electronic devices. Designs and methods are described to position multipositional text and data input elements on the backside and the frontside of the device or on the backside and the frontside of a protective case into which a device is placed. Multipositional text and data input elements according to described embodiments are positioned to provide convenient and rapid backtyping, while not significantly increasing the overall thickness of the device and the case as compared to the overall thickness of a similar-sized prior art device or a device placed in a similar-sized prior art protective case. Designs and methods are described to transfer data resulting from activation of input elements to portable electronic devices. Multipositional text and data input systems designed for use with a capacitive touch panel of a portable electronic device are described.

### BRIEF DESCRIPTION OF THE DRAWINGS

FIGS. 1(a)-1(f) depict the top and bottom views of an embodiment of a data input system for a portable electronic device.

FIGS. 2(a)-2(b) illustrate a section of the side view of an embodiment of a data input system for a portable electronic device.

FIGS. 3(a)-3(c) illustrate top views of an embodiment of a data input system for a portable electronic device.

FIGS. 4(a)-4(b) illustrate a side view of an embodiment of a data input system for a portable electronic device.

FIGS. 5(a)-5(b) illustrate a side view of an embodiment of a data input system for a portable electronic device.

FIGS. 6(a)-6(b) illustrate a side view of an embodiment of a data input system for a portable electronic device.

FIGS. 7(a)-7(b) illustrate a side view of an embodiment of a data input system for a portable electronic device.

FIG. 8 illustrates an embodiment of a multipositional text and data input element.

FIGS. 9(a)-9(b) illustrate the operation of a multipositional text and data input element.

FIG. 10 illustrates an embodiment of multipositional text and data input element.

FIG. 11 illustrates the operation of a multipositional text and data input element.

FIG. 12 illustrates an embodiment of multipositional text and data input element.

FIG. 13 illustrates an embodiment of multipositional text and data input element.

FIG. 14 illustrates an embodiment of a data input system for a portable electronic device.

FIG. 15 illustrates an embodiment of a multipositional text and data input element.

FIG. 16 illustrates the operation of a multipositional text and data input element.

FIG. 17 illustrates an embodiment of a data input system for a portable electronic device.

FIG. 18 illustrates an embodiment of a data input system for a portable electronic device.

FIG. 19 illustrates a section of the side view of an embodiment of a data input system for a portable electronic device.

FIG. 20 illustrates an embodiment of a multipositional text and data input element.

FIG. 21 illustrates an embodiment of a multipositional text and data input element.

FIG. 22 illustrates an embodiment of a multipositional text and data input element.

### DETAILED DESCRIPTION OF THE INVENTION

In the following detailed description, reference is made to the accompanying drawings, which form a part of the description and in which are shown, by way of illustration, specific example embodiments. The example embodiments are in such detail as to clearly communicate the invention. However, the amount of detail offered is not intended to limit the anticipated variation of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

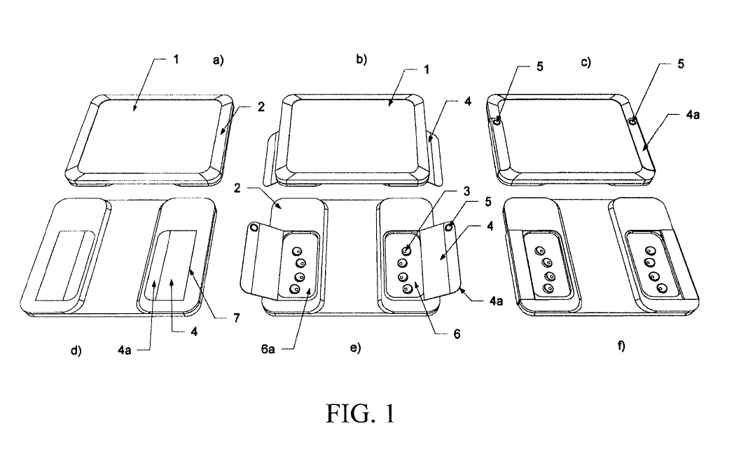

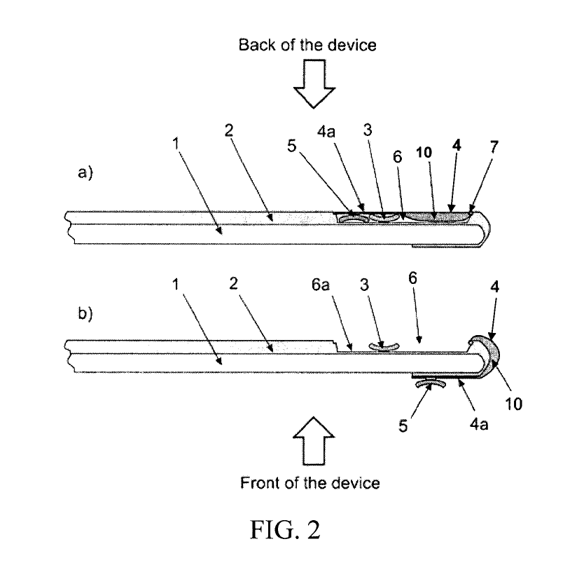

FIGS. 1 and 2 illustrate an embodiment of a data input system. FIGS. 1 (a)-(c) illustrate views of the system which faces the user (views of the frontside of the system). FIG. 1(d)-(f) illustrate the corresponding views of the backside of the system. The system includes a protective case 2 for a portable electronic device 1. Protective case 2 includes compartments 6 having a bottom surfaces 6a, said compartments 6 located on the left and the right side of the backside of case 2. (FIG. 1(e)). Flaps 4 are rotatably connected to case 2 and cover compartments 6 when case 2 is in the folded position. (FIG. 1(d)). Flaps 4 may be connected to case 2 by a hinge or any suitable means known in the art. A plurality of multipositional text and data input elements 3 for use by the operator's fingers are located on bottom surfaces 6a of compartments 6. (FIG. 1(e)). A plurality of multipositional text and data input elements 5 for use by the operator's thumbs are located on surfaces of sections 4a of flaps 4 that face the interior of case 2 when case 2 is in the closed position. (FIG. 1(e)). As illustrated in FIG. 1 (d), in the folded position of case 2, flaps 4 cover compartments 6, and input elements 5 are in the interior cavity of compartments 6. In the unfolded (operational) position of case 2, flaps 4 wrap around the lateral sides of a case 2, so that surfaces 4a with input elements 5 for thumbs are located on front side of the device facing the user. (FIGS. 1(c), 1(f). In this position, input elements 3 are available for text and data input by the operator's fingers on the backside of the device, and input elements 5 are simultaneously available for text and data input by the operator's thumbs on the frontside of the device. (FIGS. 1(c); 1(f). In an embodiment, flaps 4 may be held in position covering compartments 2 by force of magnetic attraction or any suitable means known in the art. In an embodiment, flaps 4 may be held in position wrapped around the lateral sides of a case 2 by force of magnetic attraction or any suitable means known in the art.

FIGS. 2(a) and (b) illustrate a section of the side view of the data input system. Flaps 4 are rotatably connected to cover 2 at surfaces 7 by a hinge or any suitable means known in the art. According to an embodiment, flaps 4 have an ergonomic section 10 to increase the thickness of the data input system on the lateral side of the device where it is held by the user.

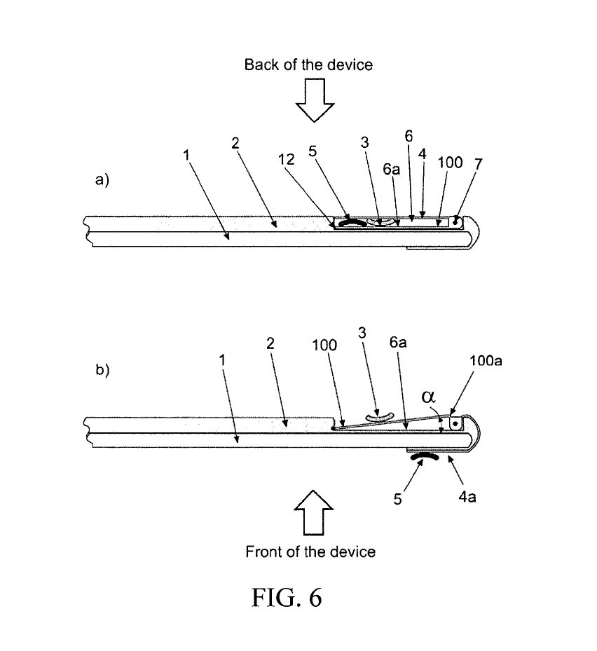

FIGS. 6(a) and (b) illustrate a section of side view of another example of a data input system. The system includes a protective case 2 for a portable electronic device 1. Protective case 2 includes compartments 6 located on the left and the right side of the backside of case 2. Flaps 4 are rotatably connected to case 2 at surfaces 7 by a hinge or any suitable means known in the art. Flaps 4 cover compartments 6 when case 2 is in the folded position. (FIG. 6(a)). A plurality of multipositional text and data input elements 5 for use by the operator's thumbs are located on the interior-facing surfaces of sections 4a of flaps 4. (FIG. 6 (b)). As illustrated in FIG. 6(a), in the folded (non-operational) position of case 2, flaps 4 cover compartments 6, and input elements 5 are placed into the interior cavity of compartments 6. In the unfolded (operational) position of case 2, flaps 4 wrap around the lateral sides of a case 2, so that surfaces 4a with input elements 5 for thumbs are located on front side of the device. (FIG. 6(b).

In this embodiment, a plurality of multipositional text and data input elements 3 for use by the operator's fingers are located on elements 100. (FIG. 6(b)). In a preferred embodiment, elements 100 are rigid-flex elements comprising a combination of flexible and rigid substrates laminated into a single element by means known in the art. Elements 100 are located inside compartments 6 on the left and the right side of the backside of case 2. Elements 100 are connected to case 2 along edges 7 by a hinge or any suitable means known in the art that would allow edge 100a of elements 100 to tilt away from surface 6a of the indentation 6 at an angle α in the unfolded (operational) position of case 2

Input elements 3 are covered by flaps 4 when case 2 is in folded position. (FIG. 6(a)). When case 2 is in the folded (non-operational) position, thumb input elements 5 are located in the same compartments 6 where finger input elements 3 are also located. (FIG. 6(a)). In an unfolded (operational) position, flaps 4 wrap around the lateral sides of case 2 so that input elements 5 located on surfaces 4a face the front of device 1 and the user. (FIG. 6(b)). Moving flaps 4 allows edge 100a of elements 100 to tilt at an angle α away from the plane of device 1. In this position, input elements 3 are available for text and data input by the operator's fingers on the backside of the device, and input elements 5 are simultaneously available for text and data input by the operator's thumbs on the frontside of the device. (FIG. 6(b)). Tilting elements 100 and data input elements 3 at an angle preserves the convenience and ease of moving the input element in the direction of finger unbending and bending for text and data input by the operator's fingers on the backside of the device

The above-described embodiments of data inputs system for portable electronic devices are advantageous for at least the following reason. Locating input elements 5 on flaps 4 means that in the folded position, the overall thickness of the device and the case including the data input system is not significantly greater that the overall thickness of a device in a similar-sized prior art protective case. When folded, case 2 looks and functions like an ordinary protective case, and will not interfere or impede the use of the device in applications that do not require the use of the data input system, for example, touch screen operations. Input elements 3 are protected by flaps 4 from accidental activation when case 2 is in a folded position. Input elements 3 and 5 don't interfere with holding the device comfortably when case 2 is in the folded position and input elements 3 and 5 are not in use. On the other hand, when case 2 is open and flaps 4 are wrapped around device 1 (FIGS. 1(c) and (f)), the combined thickness of the cover and device is increased on the lateral sides of the case where it is held by the user by addition of ergonomic surface 10 of flaps 4 (FIG. 2(b)), allowing more comfortable holding and more rapid typing or data input by the operator. Thickness of flaps 4 and the corresponding depth of compartments 6 can be selected to improve the ease of holding and use of the device, without increasing the overall thickness of the case and device in the folded position.

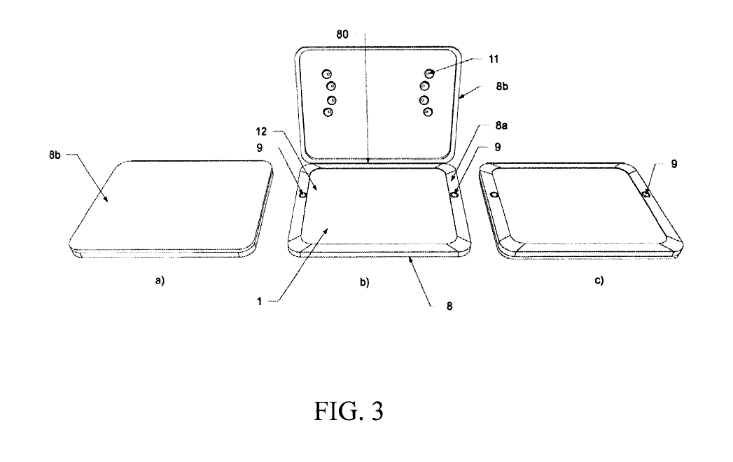

FIGS. 3(a)-(c) illustrate an embodiment of a data input system. The system includes a protective case 8 for a portable electronic device 1. Case 8 consists of two parts, 8a and 8b, rotatably connected with each other at upper edge 80 of case 8 by a hinge or any other suitable means known in the art. Portable electronic device 1 is placed inside part 8a of case 8. A plurality of multipositional text and data input elements 9 for use by the operator's thumbs are located on the left and the right side of part 8a of case 8. (FIG. 3(b), 3(c)). A plurality of multipositional text and data input elements 11 for use by the operator's fingers are located on the inner surface of case part 8b, and face screen 12 when case 8 is in folded (non-operational) position. (FIG. 3(b)). Part 8b, when case 8 is in folded position, covers and protects screen 12 and input elements 9. (FIG. 3(a)). To unfold case 8 into its operational position, part 8b of case 8 is rotated over the upper edge 80 so that the inner surface of part 8b on which elements 11 are located is now on the backside of the device. When case 8 is in its operational position, input elements 11 become accessible for the fingers of the user on the backside of the device, and input elements 9 become accessible for use by the operator's thumbs on the frontside of the device. (FIGS. 3(b), 3(c)). Locating the input elements as described in this disclosure allows reducing the overall thickness of the device and the case.

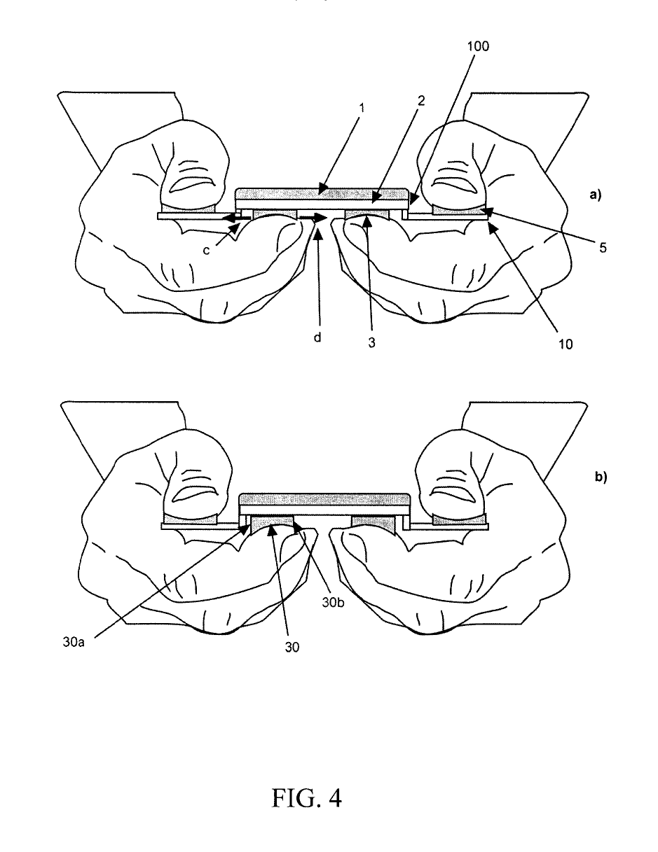

FIGS. 4(a)-(b) illustrate another embodiment of a data input system. A narrow portable electronic device may not comfortable to hold with both hands. By making a portable devices wider and, as a consequence, more comfortable to hold (for example, with a help of side handles), the portability of the device suffers. Solutions are proposed to keep the device compact and portable, and, at the same time, to make it comfortable to hold and use while inputting data or characters. FIG. 4(a) shows a portable electronic device 1 placed in case 2. Case 2 is shown in an unfolded (operational) mode in FIG. 4(a). Case 2 includes side handles 10 rotatably connected to case 2 at edges 100 by any suitable means known in the art. A plurality of multipositional text and data input elements 5 for use by the operator's thumbs are located on the top surfaces of handles 10 facing the user when the system is in an unfolded (operational) position. (FIG. 4(a)). A plurality of multipositional text and data input elements 3 for use by the operator's fingers are located on the bottom surface of case 2 when the system is in an unfolded (operational) position. (FIG. 4(a)). Rotating side handles 10 unfolds the system into its operational mode and makes input elements 3 available for text and data input by the operator's fingers on the backside of the device. Arrows “c” and “d” illustrate direction of movement of multi-positional input elements 3 by the tips of the user's index fingers in the direction of bending (arrow “c”) and unbending (arrow “d”).

For the flat input elements, the fingertip is the main part of a contact between the element and the finger. It is known in the art that for most users, moving an input element in the direction of unbending the finger away the palm is fairly easy and straightforward. However, when moving an input element in the direction of bending the finger towards the palm, additional pressure of the finger on the input element in the direction perpendicular to the plane of the device (i.e., vertical direction) is required to prevent any slippage of the fingertip off of the input element. The index finger is generally strong and mobile enough to provide sufficient pressure to successfully move the input elements in directions of both unbending and bending. However, other human fingers are generally known to be weaker and less mobile than the index finger, and may have a greater difficulty in applying sufficient vertical pressure to move the input elements in the direction of bending, which may lead to a general reduction in the speed of typing or data entry. FIG. 4b illustrates an embodiment of a data input system to solve this problem. A plurality of multipositional text and data input elements 30 for use by the operator's fingers are located on the bottom surface of case 2 when the system is in an unfolded (operational) position. Input elements 30 for use by the operator's fingers have an outer lateral surface having a height 30a and inner lateral surface having a height 30b. According to an embodiment, outer height 30a is greater than inner height 30b, which increases the contact area between the finger and the input element. While preserving the convenience and ease of moving the input element in the direction of unbending, the convenience and ease of moving the input elements in the direction of bending is improved. Vertical pressure on the input element is not required—all the user needs to do is to bend the finger, and the fingertip will catch the raised outer end of the input element.

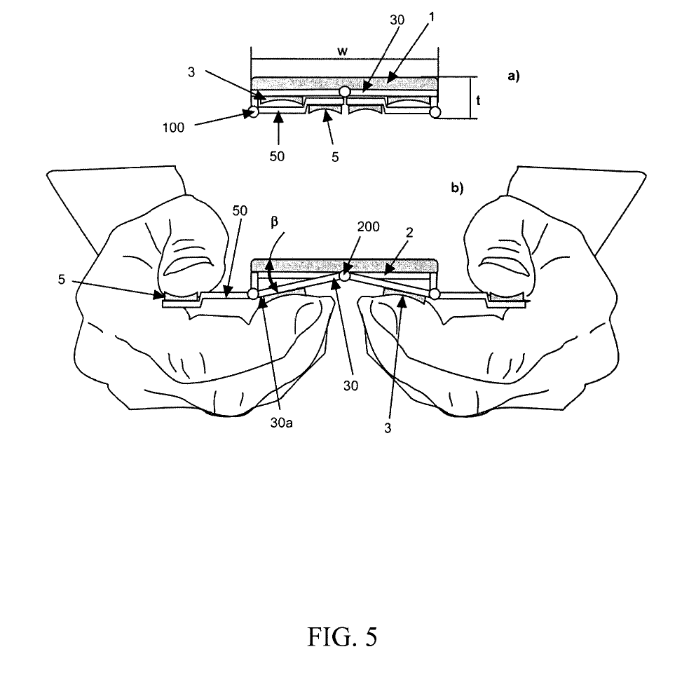

Increasing the height of the outer lateral surface of the input element may lead to an increase of overall thickness of the device and the case. FIGS. 5(a) and (b) illustrate an embodiment of a data input system for handheld devices where an increase of overall thickness of the device and the case in operational mode by even a few millimeters may be significant. FIG. 5(a) shows a portable electronic device 1 placed in case 2 where case 2 is in a folded (non-operational) mode. Data input system according to this embodiment of the present invention includes side handles 50 rotatably connected to case 2 at edge 100 by a hinge or any other suitable means known in the art. Data input system also includes tilting elements 30 rotatably connected to case 2 along surface 200 by a hinge or any other any suitable means known in the art that would allow edge 30a of elements 30 to tilt away from the bottom of case 2 at an angle 13 relative to the plane of case 2.

FIG. 5(b) shows case 2 in an unfolded (operational) mode. As illustrated in FIG. 5(b), a plurality of multipositional text and data input elements 3 for use by the operator's fingers are located on the bottom surfaces of tilting elements 30. A plurality of multipositional text and data input elements 5 for use by the operator's thumbs are located on top surfaces of side handles 50. Side handles 50 can be extended out by rotating them around edge 100 for easy holding of the device and for operation of input elements 5 by the operator's thumbs. Rotating side handles 50 makes input elements 3 available for text and data input by the operator's fingers on the backside of the device. As illustrated in FIG. 5(b), in operating mode of the system, outer edges 30a of tilting elements 30 rise at an angle 13 to the plane of case 2. The proposed solution improves the convenience and compactness of the device when using the multipositional input elements, and also improves the usability of finger movements between several individual fairly flat input elements. Tilting surfaces on which data input elements 3 are located at an angle preserves the convenience and ease of moving the input element in the direction of finger unbending and bending for text and data input by the operator's fingers on the backside of the device.

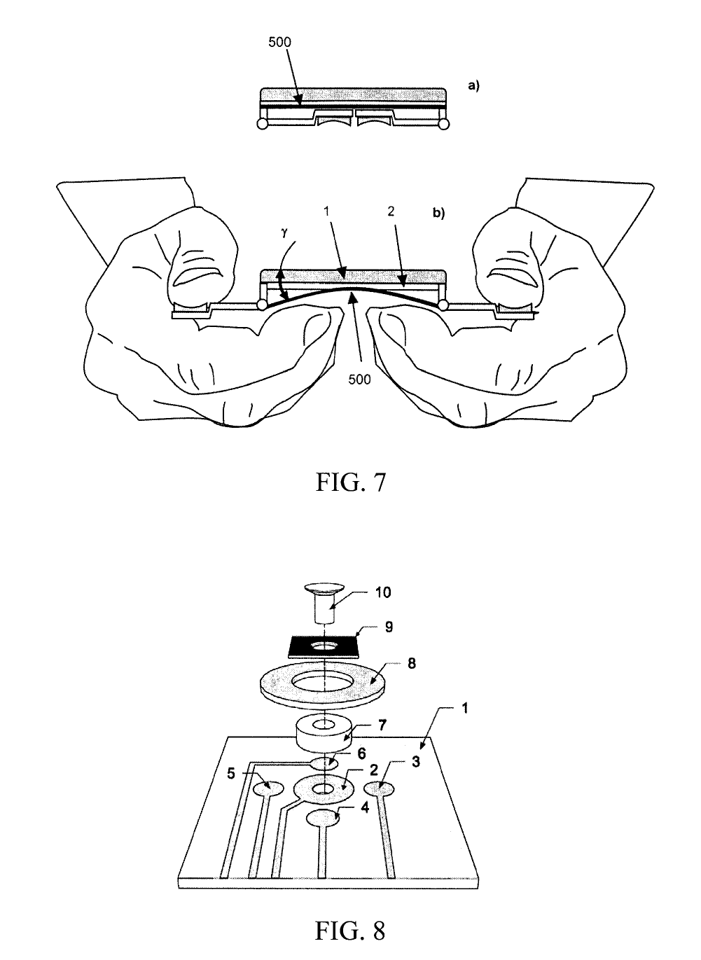

FIG. 7 illustrates another embodiment of a data input system. In this embodiment, tilting surfaces 30 and input elements 3 are replaced with sensory surfaces 500. In a preferred embodiment, sensory surfaces 500 are rigid-flex elements comprising a combination of flexible and rigid substrates laminated into a single element by means known in the art. In an embodiment illustrated in FIG. 7(b), sensory surfaces 500 are formed so that the outer edges of surfaces 500 are farther away from the bottom of case 2 than the middle parts of the surfaces 500. In an embodiment, the outer edges of surfaces 500 are tilted at an angle γ away from the plane of case 2. In an embodiment, sensory surfaces 500 are concave. Tilting the edges of surfaces sensory surfaces 500 at an angle γ, or forming sensory surfaces 500 as concave, preserves the convenience and ease of moving the finger along the sensory surface in the direction of finger unbending and bending for text and data input by the operator's fingers on the backside of the device.

Designs and methods of use of the multipositional text and data input elements are now described. In order to achieve the required properties of data input elements for portable electronic devices, such as reliability, ease of manufacture, small size, short stroke, soft triggering, low rattle effect of the contacts, good tactile feedback and low percentage of false triggering, the force of magnetic attraction is used in the proposed solution as a force that counteracts the pressure of the user's finger and returns the element to home position after data or text input. Using the power of magnetic drag in the multi-positional input elements allows getting cheap, reliable and easy-to-work input elements with smooth and stable characteristics. Such elements can be used in applications that require high-speed interaction with input elements, such as keyboards and joysticks in mobile devices.

To implement multipositional text and data input elements according to this invention, an input element which consists of two parts is proposed, characterized in that one of the parts of the input element is stationary relative to the portable electronic device, and the other part of the input element is movable by user's finger in order to establish an electrical connection to effectuate input of text or data into the device. One of these parts contains magnet elements, and the other part contains elements made out of a ferromagnetic material such as steel. When the input elements are not in use, magnetic force keeps the parts in equilibrium. By tilting the movable part of the input element in various directions relative to the stationary part, the user causes a partial separation of the magnetic contact between the movable and stationary parts of the input element. Further movement of the finger leads to establishing of a new contact, in the direction of movement chosen by the user. There is no need to use small deformable parts such as springs, which improves the reliability and the ease of assembly of the input elements.

Unlike mechanical springs which may be used to snap an item back into its original position after movement, the force of magnetic attraction is not amplified with the increased distance between two attracting bodies. Instead, the force of magnetic attraction quickly decreases with the increased distance between two attracting bodies. It requires a significant initial effort to break apart the contact between two parts held together by magnetic force, but the strength of the magnetic force rapidly declines with distance. After making a significant initial effort to break the magnetic connection, the user's finger continues to move the input element due to inertia, and therefore the moving part of the input quickly touches the stationary part to make contact with it in order to input data or text.

In the beginning of the motion to move the input element by finger pressure, the finger presses on the input element with less force than is required to break the contact between two parts held together by magnetic force. The triggering of the input element cannot occur at this phase, because all parts of the input element are still stationary. As the motion continues, the strength of pressure of the user's finger exceeds the strength of the magnetic connection and breaks the magnetic contact between the moving and stationary parts of the input element. The finger starts to move the input element rapidly in the direction of the motion of the finger. The speed of the movement is high due to the fact that the finger is still being moved by the strong force that was applied by the user to break the magnetic connection, while the magnetic force between the parts after breaking the contact decreases rapidly with the increase of the distance between them, and therefore does not slow down the motion of the finger and the input element.

Thus, in the described embodiment, good contact between the moving and stationary parts of the input element occurs with high probability and in a short period of time. The closing of the contact occurs with minimum rattle. This leads to a good tactile feedback when working with the input element—the user clearly feels the fact of triggering of the element. With such a design, the input element will have a very slow stroke, without increasing of probability of undesired or accidental pressing of the input element. Indeed, the effort necessary to break the magnetic contact between moving and stationary parts of the input element does not depend on how far the moving part needs to move.

FIG. 8 illustrates an embodiment of multipositional text and data input element. The stationary part of the input element according to this embodiment comprises conductive contact pads 3-6 and a conductive central contact anchor pad 2 located on base 1; washer 7; ferromagnetic element 9; and screw 10. The movable part of the input element according to this embodiment comprises magnet 8. In other embodiments, element 9 may be made out of a magnet and element 8 made out of a ferromagnetic material. Washer 7, which is made of a non-magnetic conductive material, is connected to the top of central contact anchor pad 2. Magnet 8 is placed around washer 7. Ferromagnetic element 9 is placed on top of magnet 8. Screw 10 or other connector means known in the art extends through the central openings in ferromagnetic element 9, magnet 8 and washer 7 to fixedly connect ferromagnetic element 9 to washer 7 with magnet 8 sandwiched in between.

In an embodiment, ferromagnetic element 9 is shaped as a parallelogram, and magnet 8 and washer 7 are annular-shaped. Washer 7 is sized to fit inside the inner opening of magnet 8. The length of the sides of the parallelogram comprising ferromagnetic element 9 is larger than the diameter of the inner opening of the magnet 8. In a preferred embodiment, ferromagnetic element 9 is shaped as a square. Magnet 8 is magnetically attracted to ferromagnetic element 9 and is held above contact pads 3-6 and central contact anchor pad 2 by force of the magnetic attraction between magnet 8 and ferromagnetic element 9. In a preferred embodiment, washer 7 may be made of a suitable elastic material, By tightening screw 10 and therefore decreasing the thickness of washer 7, a user may regulate the distance between ferromagnetic element 9 and contact pads 3-6 and central contact anchor pad 2, and therefore regulate the length of movement of magnet 8 which is required to establish electrical contact between magnet 8 and one of the sensor pads 3-6, as described below. Text or data input is made by closing electrical contact between magnet 8 and a desired contact pad 3-6 while maintaining electrical contact between magnet 8 and central contact anchor pad 2, which is interpreted by the software of the device as data input.

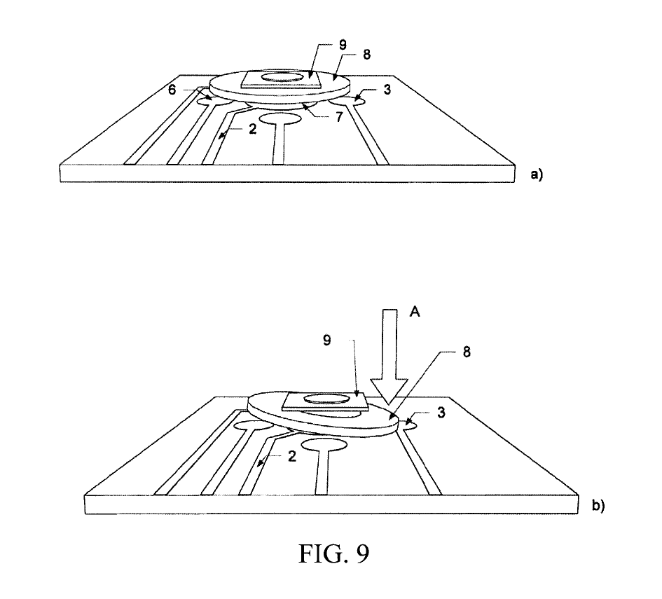

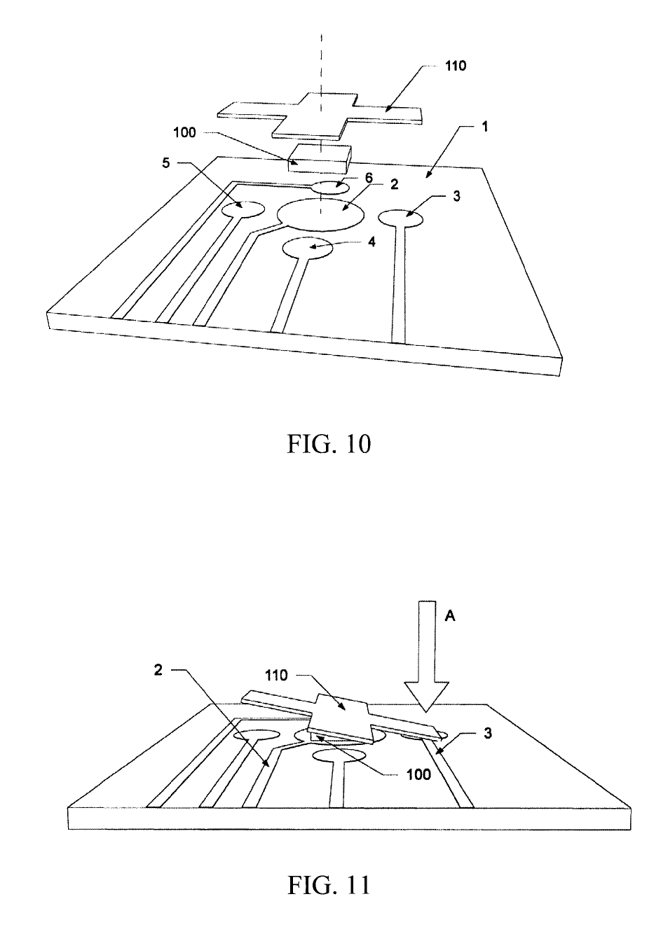

As illustrated in FIGS. 9(a) and (b), when the user presses down on an edge of magnet 8 in the direction of arrow “A”, the pressure of the user's finger causes separation of the pressed edge of magnet 8 from ferromagnetic element 9. The opposite side of magnet 8 retains contact with the corresponding side of ferromagnetic element 9. As illustrated in FIG. 9(b), when pressed down in direction of arrow “A”, magnet 8 touches contact pad 3 while maintaining contact with washer 7. Washer 7 is in contact with central contact anchor pad 2 and therefore an electrical contact chain is formed (central contact anchor pad 2 to washer 7 to magnet 8 to ferromagnetic element 9 and contact pad 3) to electrically connect central contact anchor pad 2 with contact pad 3. Electrical contact may be interpreted by the software of the device as data input. Force of magnetic attraction between magnet 8 and ferromagnetic element 9 returns magnet 8 into its original position when the pressure of the user's finger is removed.

Forming ferromagnetic element 9 in the form of a parallelogram is advantageous because a push on the edge of magnet 8 will cause it to tilt in one of the four directions (each such direction corresponding to one the sides of a parallelogram comprising ferromagnetic element 9) which increases the tactile feedback content of the input element. In another embodiment, it is possible to use eight contact pads and to form magnetic plate 9 in a form of an octagon. In an embodiment, it is possible to uniformly push down the entire magnet 8, which will cause magnet 8 to completely separate from ferromagnetic element 9 and to contact at least two sensory pads of the device. In an embodiment, it is possible to add a non-magnetic conductive interlayer between magnet 8 and ferromagnetic element 9 to lessen the force of magnetic attraction between magnet 8 and ferromagnetic element 9, in order to regulate the initial finger pressure required to move magnet 8 to close electrical contact between magnet 8 and one of the sensor pads.

FIG. 10 illustrates an embodiment of a multipositional text and data input element according to this invention. The stationary part of the input element according to this embodiment comprises conductive contact pads 3-6, a conductive central contact anchor pad 2 located on base 1; and magnet 100. The movable part of the input element according to this embodiment comprises a ferromagnetic element 110. Magnet 100 is shaped as a parallelogram and is placed on top of central contact anchor pad 2 and held there by force of magnetic attraction with ferromagnetic element 110. In a preferred embodiment, magnet 100 is shaped as a square. In other embodiments, element 110 may be made out of a magnet and element 100 made out of a ferromagnetic material. In a preferred embodiment, ferromagnetic element 110 is formed in the shape of a cross. The arms of the cruciform-shaped ferromagnetic element 110 are generally disposed in the same orientation as the sides of the parallelogram-shaped magnet 100, as illustrated in FIG. 10. The outer edges of the arms of ferromagnetic element 110 extend beyond of the outer edges of the corresponding sides of magnet 100, as illustrated in FIG. 10, and are generally disposed above contact pads 3-6.

As illustrated in FIG. 11, when the user presses down on one of the sides of ferromagnetic element 110 in direction of arrow “A”, the pressure of the user's finger causes separation of the opposite side of ferromagnetic element 110 from magnet 100. On the side where the pressure is applied, ferromagnetic element 110 retains contact with magnet 100. As illustrated in FIG. 11, when pressed down in direction of arrow “A”, ferromagnetic element 110 touches contact pad 3 while maintaining contact with magnet 100. Magnet 100 is in contact with central contact anchor pad 2 and therefore an electrical contact chain is formed (central contact anchor pad 2 to magnet 100 to ferromagnetic element 110 to contact pad 3) to electrically connect central contact anchor pad 2 with contact pad 3. Electrical contact may be interpreted by the software of the device as data input.

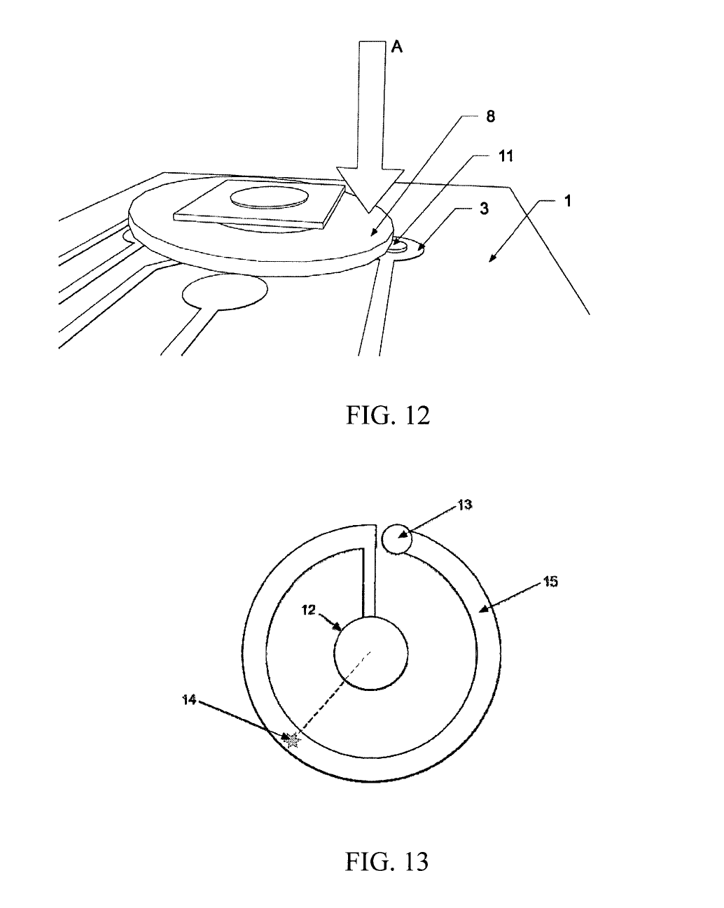

In other embodiments, additional elements made of ferromagnetic materials or magnets can be placed in the area of contact between the moving and the stationary parts. In an embodiment illustrated in FIG. 12, magnet 11 is located at contact pads 3-6. In other embodiments, element 11 may be made of a ferromagnetic material. In another embodiment, element 11 may be located under the base 1 in the location corresponding to the location of contact pad 3 on base 1 (not shown). As illustrated in FIG. 12, when the user presses down on one of the sides of magnet 8 in direction of arrow “A” and that edge of magnet 8 approaches a contact pad having element 11, magnetic attraction between magnet 8 and element 11 increases which causes the reduction of pressure required to move element 11 into contact position with contact pad 3. The size, magnetic characteristics, and the distance of travel between magnet 8 and element 11 may be selected so as to reduce the contact bounce when closing or opening the electrical connections; to provide a “sticky” keys effect if desired, up to and including fixing the movable part of the input element in the pressed position after the pressure of the user's finger is removed; and/or reduce the effort made by the user to move the input element by finger pressure.

Other arrangements of the movable and stationary parts of the input element according to the present invention are possible. For example, special conductive elements responsible for establishment of electrical contact may be included. In another embodiment, a membrane keyboard with pressure-sensitive areas located in places where contact pads 3-6 are located in the above-described embodiments, may be used instead of contact pads 3-6. Tilting of the movable part of the input element by the action of the user's finger will trigger the desired buttons on the keyboard. Other devices known in the art which allow registering of the mechanical pressure can be used instead of the membrane. Also, several individual magnets and/or ferromagnetic elements may be used instead of single magnets or single ferromagnetic elements described above.

In the above examples, multipositional text and data input elements were described which allow the user to tilt the movable part of the input element in one of several pre-determined directions, each such direction corresponding to contact pads 3-6. It is possible to create a text and data input element that would allow the user to move the movable part of the element in any direction chosen by the user. As illustrated in FIG. 13, the stationary part of the input element according to this embodiment includes a conductive central contact anchor pad 12 and a conductive strip 15. In an embodiment, conductive strip 15 is formed in the shape of an open ring and is made out of material with substantial electrical resistance. In the embodiment illustrated in FIG. 13, the pressure of the user's finger pushes down a movable part of the input element (for example, magnet 8 illustrated in FIG. 12) in a direction chosen by the user to create a new contact between magnet 8 and stripe 15 at a position 14 corresponding to the direction of movement chosen by the user. This contact may be interpreted by the software of the device as data input.

Next, ergonomically advantageous locations of placement of the input elements on the backside of the unit (facing away from the user during the text typing) are described. One way to solve the problem (described in the Background section) of allowing people with different sized hands to work comfortably with the input elements for is to manufacture products with different-sized input elements, like making gloves in sizes XS, S, M, L, XL. A drawback of this method is the complexity of predicting and maintaining required production volumes for each size of the input elements, and the inability to custom-fit a device for a specific user. Another way to solve this problem is to change the geometry of the surface where the user holds the device. For example, there are special linings, which increase the size of side handles for an AlphaGrip keyboard for users with big palms. This approach is not very flexible in terms of adaptation, because it does not change the distances between input elements. Also, this approach is problematic in terms of the design, since the device without linings looks more attractive than the device with linings. Therefore, it would be advantageous to create a device in which the input element locations could be adapted to any size of the hand without hurting the appearance, compactness and/or other device properties that consumers find appealing. However, some solutions to this problem can lead to an increase in the complexity of the design and to a number of technical problems. Mechanical systems for moving input elements must have high reliability with small dimensions. The activation of the mechanical systems that change the layout of the input elements should be simple enough for the user to use when desired, but should not happen by accident.

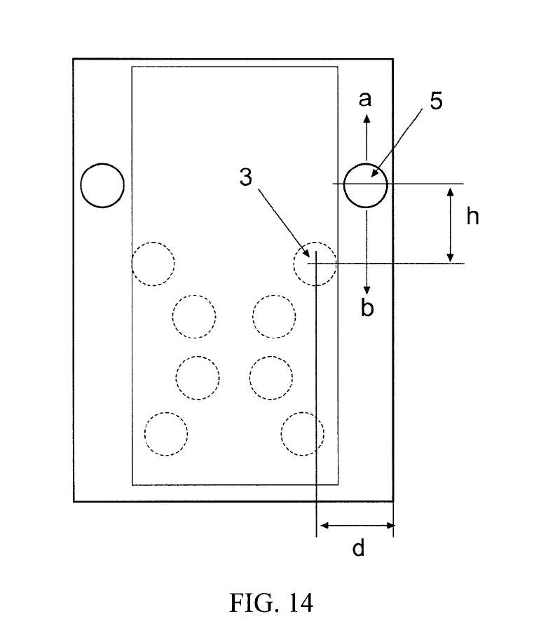

Several solutions are proposed to solve the problem of ergonomic design of the text and data input system for users with different-sized hands and fingers. For systems described above and illustrated in FIGS. 1 and 2, one of the important parameters for convenience of use is the distance from the center of the input element 3 for use by the index finger on the backside of the device to the center of the input element 5 for use by the thumb on the front side of the device (distance “h” illustrated in FIG. 14). Thus, a substantial increase of comfort can be achieved by moving the input elements for thumbs along the sides of the case of the device in directions ‘a’ or ‘b’, as illustrated in FIG. 14. Another important parameter for convenience of use is the distance from center of a finger input element to the corresponding edge of the case (distance “d” illustrated in FIG. 14). For cases with side handles, the distance from the input elements for fingers to the corresponding edge of the case can be controlled by limiting the distance of how far the side handles are extended out. However, the use of the two solutions described above (moving the input elements for thumbs along the sides of the case and/or limiting the distance of how far the side handles are extended out) does not completely solve the problem of the ergonomic use of the device by people with different-sized hands and fingers, since it does not allow the user to adjust the distance between the individual finger input elements on the backside.

According to an embodiment, input elements on the backside of the device may be held in place by magnetic attraction between a magnet (which may be a part of the input element) and the back surface of the device which made of a ferromagnetic material. Thus, the input elements can be moved around the backside of the device under the force of the user's fingers. The unwanted movements of the input elements when typing can be eliminated by using friction pads between the input element and the magnetic surface. The friction pads are selected so that the force applied by the user when typing is much less than the force of static friction that holds the input element in place. This embodiment allows the user to freely change the location of the input elements on the back surface of the device while dispensing with complicated mechanisms of moving the input elements and fixing their new locations on the backside of the device after each move. In embodiments described in FIGS. 8-13, above, the ferromagnetic elements that return the input element to its home position after pressing may be used to hold the input element on the magnetic surface on the backside of the device. Thus, no new parts are added to the input element, and the overall thickness of the case and device doesn't increase.

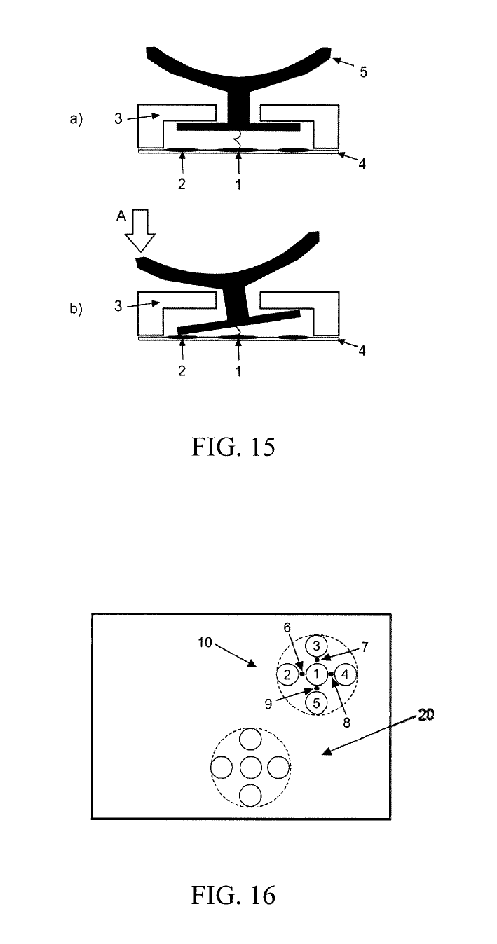

FIG. 15 illustrates an embodiment of multipositional text and data input element according to this invention. The input element according to this embodiment consists of a magnet 3; a board 4 located on a ferromagnetic surface of a portable electronic device and having a central contact anchor pad 1 and a plurality of directional contact pads 2; and button 5 held in place by magnet 3. Button 5 is electrically connected to central contact anchor pad 1 and is held in place above board 4 by magnet 3. In the non-operational state, as illustrated in FIG. 15(a), button 5 is electrically connected to central contact anchor pad 1 but is not electrically connected to any of the directional contact pads 2. When the user presses down on one of the sides of button 5 in direction of arrow “A”, as illustrated in FIG. 15(b), the corresponding side of button 5 contacts one of the plurality of directional contact pads 2, creating electrical contact between connect central contact anchor pad 1 and one of the plurality of directional contact pads 2. Electrical contact may be interpreted by the software of the device as data input.

Next, transferring of data to the device resulting from pressing of input elements which are magnetically connected to the backside of the device is described. One option is to transfer the data by closing of electrical connection through conductive wires or through tracks of flexible conductive cable, which connect the input elements with the device and which do not hinder the movement of the input elements in any direction. This solution may slightly limit the freedom of movement of the input elements, and also leads to the problem of designing an attractive device, since the cables should be hidden from view without unduly limiting the mobility of the input elements. This problem of design may be solved by using a flexible protective surface on which the input elements are mounted. The surface should have enough flexibility or elasticity to allow movement of the input elements within specified limits on the magnetic backside of the device. The loops of wire or cables that connect the input elements to the device may be hidden between the magnetic backside of the device and the flexible decorative protective surface. The protective surface can be made, for example, of silicone, leather or leatherette, or other suitable materials known in the art.

Another option to transfer data resulting from pressing of the input elements to the device involves using an active surface with the input elements located on it. The touching of the input element by the user is detected by the active surface of the device on which the input element is located, and is interpreted by the software of the device as data input. If the active surface can support detection of multiple simultaneous touches, it becomes possible to locate multiple input elements on the backside of the device. FIG. 16 illustrates an embodiment in which capacitive touch pads allow detecting multiple simultaneous movements of multipositional text and data input element 10. Other materials such as resistive panels, on which the element must be physically pressed when moved towards the side, can be used instead of capacitive panels. Capacitive panels are preferred over resistive panels due to their greater mechanical reliability.

As illustrated in FIG. 16, input element 10 is disposed on sensory surface 20 of a portable electronic device. A central capacitive pad 1 and peripheral capacitive pads 2-5 are located on the bottom of input element 10. The central pad 1 is galvanically connected to a button top (not shown), which allows the input element to be touched, pressed and/or tilted by the user's finger during operation. When the user places a finger on the button top, 1 electrical capacity of the user's body will be connected to the central pad 1 via the user's finger and the button top, and sensory surface 20 will register a touch at the location of central capacitive pad 1.

In an embodiment where peripheral capacitive pads are located sufficiently far from each other and from central capacitive pad 1 for the sensory service of the device to detect multiple touches, when the user touches the button top and simultaneously moves input element 10 in the directions of peripheral capacitive pad 2, sensory surface 20 will register two simultaneous touches, one at the center of pad 1, and the other at the center of pad 2. These can be detected by software and interpreted as contact with pad 2. Similarly, when the input element is moved in the direction of peripheral capacitive pads 3, 4, or 5, the capacitive touchpad will register two simultaneous closings of electrical contact, one at the center of pad 1 and the other at the center of pads 3, 4, or 5, respectively, which can be detected by software and interpreted as contact with pads 3, 4, or 5. A device with eight input elements on the backside must be able to identify up to 16 simultaneous touches.

In another embodiment, peripheral capacitive pads and central capacitive pad are located close to each other so that a simultaneous touch on the central pad and a peripheral pad will be interpreted by the device as a single touch In that embodiment, when the user touches the button top and simultaneously moves input element 10 in the directions of peripheral capacitive pad 2, sensory surface 20 will register a touch at point 6, which is shifted relative to the center of central capacitive pad 1 towards the center of peripheral capacitive pad 2. (FIG. 16). Contact at point 6 can be detected by software and interpreted as contact with pad 2. Similarly, when the input element is moved in the direction of peripheral capacitive pads 3, 4, or 5, this movement will be registered at the points 7, 8, or 9, respectively, and can be detected by software and interpreted as contact with pads 3, 4, or 5, respectively.

Next, a multipositional text and data input element designed for use with a capacitive touch panel of a portable electronic device is described. The input element according to this invention can be used for entering information into a portable electronic device with a display and at least one touch pad, such as a tablet or a smartphone. The input element according to this invention can be used as removable accessory for a portable electronic device and doesn't require its own power source or any hardware support from the portable electronic device other than a standard input interface.

The input element according to this invention comprises at least one activator part located on the touch pad of the portable electronic device in a fixed position. Activator parts are made of an electrical conductor material and have low electrical capacity. The input element also comprises at least one external input part electrically connected to the activator part. External input parts are made of an electrical conductor material and are used to establish a galvanic or capacitive coupling between the activator part and an external body with a sufficient electrical capacity, such as a human body. Touching of an external input part by the user leads to the registration of a contact at the location of a corresponding activator part connected to said external input part, and can be programmatically translated into appropriate action of a portable electronic device, for example, data or text input or a required action in a computer game. It is also possible for the user to touch several input parts simultaneously, and touchpads known in the art may be able detect multiple simultaneous touches.

The input element according to this invention has at least two states. In the first state of the input element, the “inactive” state, the user is not touching external input part, and therefore the activator elements are not electrically connected to an external body with a sufficient electrical capacity, such as a human body. In this state, the capacitive touch panel of a portable electronic device does not register a touch at the location of the activator element. In the second state of the input element, the “active” state, a user touches an external input part with his or her finger, and therefore galvanic or capacitive coupling arises between the activator element and the user's body. In this state, the touch pad registers a touch at the location of the activator element corresponding to the external input part touched by the user.

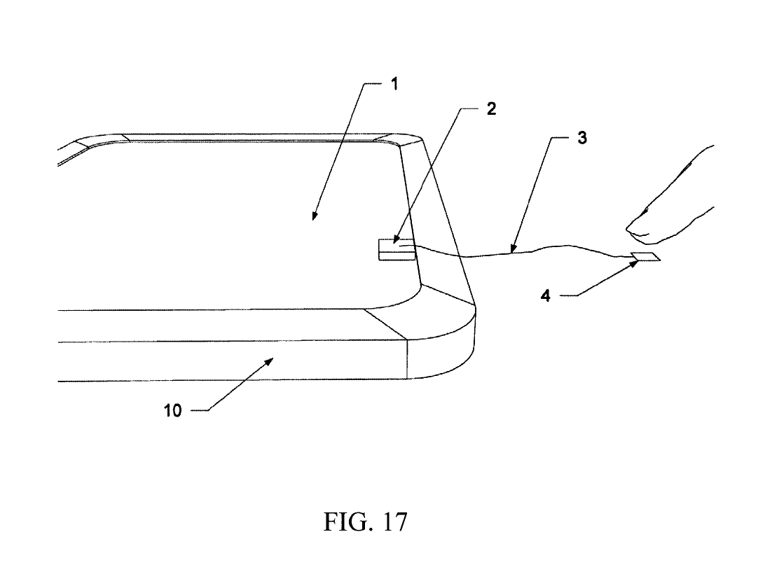

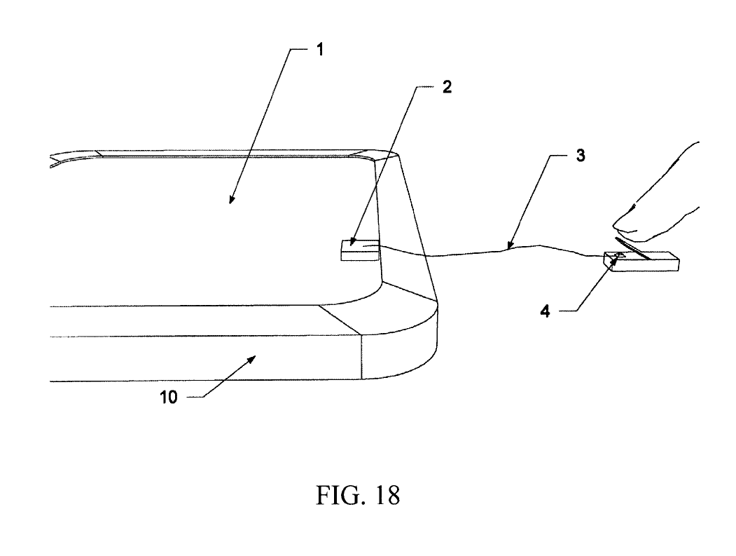

FIGS. 17 and 18 illustrate embodiments of a data input element according to this invention. A plurality of activator parts 2 may be located on touch panel 1 of a portable electronic device 10. Activator parts 2 are made of a conductive material and have contact surface areas which are greater or equal to the minimum area of a touch spot which the touch panel is designed to detect. A plurality of external input parts 4 may be spaced from activator parts 2 and electrically connected to them by conductors 3, which should have low capacity and it must be sufficiently isolated from parasitic capacitive coupling. In an embodiment, external input part 4 may be a pad for contact with user's finger. External input parts illustrated in FIG. 17 may not have textile feedback. However, they can be placed in a user-friendly ergonomic location, for example, under the fingers of the user on the backside of the device. FIG. 18 illustrates another embodiment of an input device, illustrating a mechanical external input part 4 which allows tactile feedback.

In the “inactive” state of this embodiment, the user has not pressed an external input part 4, and therefore no activator part 2 is electrically connected to an external body with a sufficient electrical capacity. Therefore, the touch panel of a portable electronic device 10 does not register a touch at the location of activator part 2. In the “active” state of this embodiment, user presses an external input part 4, creating a galvanic or capacitive contact between activator part 2 and a human body. In this state, touch panel 1 will register a touch at the location of an activator part 2 which is connected to the external input part 4 touched by the user.

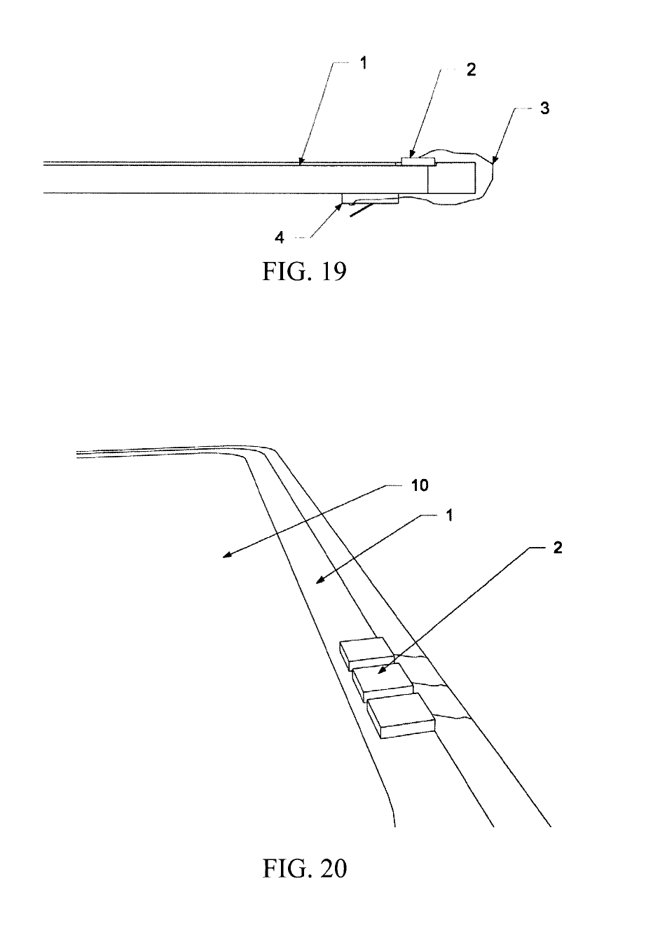

It should be noted that the location of external input parts 4 is not constrained by the location of corresponding activator parts 2. As illustrated in FIG. 19, external input parts 4 may be located on the backside of the device and be controlled by user's fingers, while corresponding activator parts 2 can be located around the perimeter of touch panel 1. As shown in an embodiment illustrated in FIG. 20, activator parts 2 may be located outside of display area 10 if touchpad 11 extends beyond at least one edge of display 10 of the device.

In an embodiment, activator parts may be made of a transparent conductive material and may be placed around the perimeter of display area of a portable electronic device, to minimize their interference with the display of information on the screen. A special attention should be paid to the problem of the relative position of the activator parts on the touchpad. One of the features of the touchpads known in the art is the ability of their controllers to combine close-located contacts into a single contact, as was discussed above. Therefore, simultaneous activation of two closely spaced activator parts may lead to the registration of a single contact at an intermediate location between the positions of these two activator parts. This undesirable effect can be avoided by placing all of the activator parts at a sufficient distance from each other.

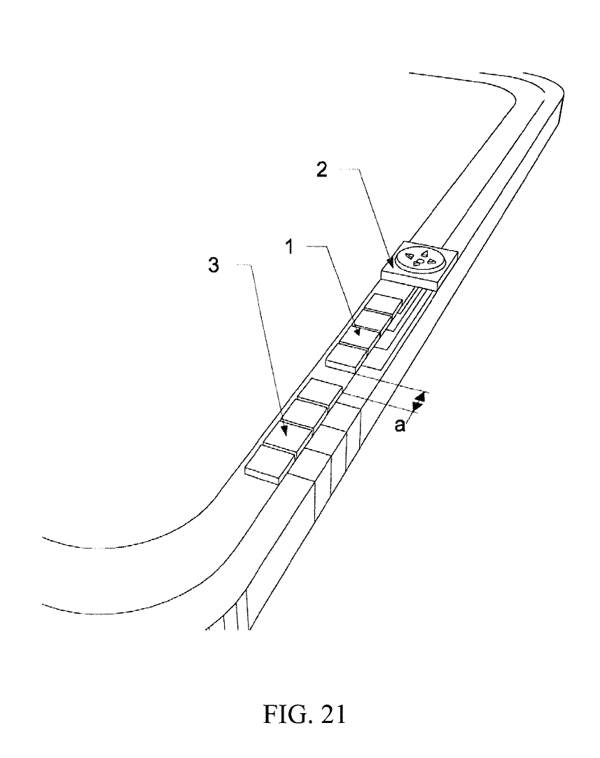

In another embodiment, as illustrated in FIG. 21, it is possible to combine activator parts into groups where only one part per group is likely to be activated at a time. In this embodiment, it is sufficient to maintain the necessary distance between the groups of activator parts, as opposed to between each individual activator, saving space on the device. As illustrated in FIG. 21, group 1 of activator parts consists of four parts, each electrically connected to a mutlipositional input part 2 operated by the user's thumb. Group 3 of four activator parts is spaced from group 1 by distance ‘a’. Each of the activator parts in group 3 is electrically connected to one of external input parts (not shown) which are operated by the user's fingers on the backside of the device.

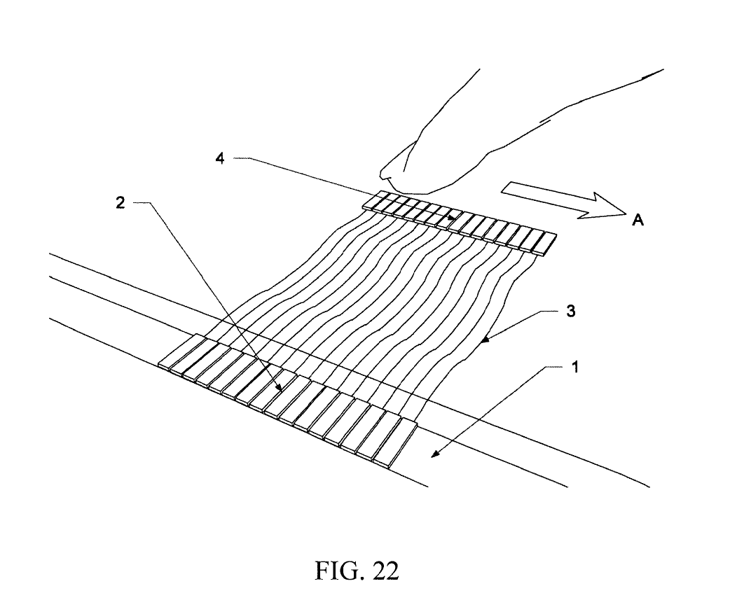

It is possible to use activator parts with the area of contact of each individual part is insufficient for the touchpad to register the touching. In that embodiment, the simultaneous activation of several adjacent activator parts leads to the registration of a contact near the geometric center of the activated activator parts. FIG. 22 illustrates an embodiment of an input element where activator parts 2 located on touch pad 1 comprise closely spaced conductive strips. Corresponding external input parts 4 comprise closely spaced conductive strips. Each of activator parts is electrically connected to a corresponding external input part 4 by a conductor 3. If, for example, the user moves a finger across external input part 4, activator parts 2 will register a continuous movement of spot of contact, which can be interpreted by an application, for example, as scrolling.

It will be apparent to those skilled in the art having the benefit of this disclosure that the inventions shown and described in the detailed description and the figures are to be taken merely as examples. It is intended that the following claims be interpreted broadly to embrace all the variations of the example embodiments disclosed. Although the present invention and some of its advantages have been described in detail for some embodiments, it should be understood that various changes, substitutions and alterations can be made herein without departing from the spirit and scope of the invention as defined by the appended claims. Further, embodiments may achieve multiple objectives but not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A data input system for a portable electronic device comprising:
a case having a top side, a bottom side, a front side, a back side, a left side and a right side, wherein said back side includes at least one compartment having a bottom surface and at least one cover, and wherein said cover is connected to said back side of the case and is operative to fold over the left side or the right side of the case to open said compartment;
a first set of movable data input elements;
a second set of movable data input elements;
wherein said first set of data input elements is placed on said cover and becomes accessible for data input on the front side of the case when said cover is folded over the left or the right side of the case and the compartment is open; and
wherein said second set of data input elements is placed on said bottom surface of said compartment and becomes accessible for data input on the back side of the case when said cover is folded over the left or the right side of the case and the compartment is open.

2. A data input system according to claim 1, wherein said first set of data input elements is movable by thumb pressure.

3. A data input system according to claim 1, wherein said second set of data input elements is movable by finger pressure.

4. A data input system according to claim 1, wherein said cover includes an ergonomic portion.

5. A data input system according to claim 1, further comprising a movable part located inside said compartment and having said second set of data input elements located on said movable part.

6.-31. (canceled)

32. A data input system for a portable electronic device comprising:
a portable electronic device having a top side, a bottom side, a front side, a back side, a left side and a right side, wherein at least one compartment is connected to the bottom side of said device and having a bottom surface and at least one cover, and wherein said cover is operative to fold over the left side or the right side of the device to open said compartment;
a first set of movable data input elements;
a second set of movable data input elements;
wherein said first set of data input elements is placed on said cover and becomes accessible for data input on the front side of the device when said cover is folded over the left or the right side of the device and the compartment is open; and
wherein said second set of data input elements is placed on said bottom surface of said compartment and becomes accessible for data input on the back side of the device when said cover is folded over the left or the right side of the device and the compartment is open.

33. (canceled)

34. A data input element for a portable electronic device comprising:
a first part connected to a portable electronic device and having at least one magnetic element and at least one area for detecting and communicating data input to said device; and
a second part connected to said first part and operative to enter data into said device, said second part having at least one magnetic element electrically connected to said magnetic element of said first part,
wherein pressure on a side of said second part moves said magnetic element of second part to contact said area for detecting and communicating data input of said first part while maintaining contact between said magnetic element of said second part and said magnetic element of said first part on the side opposite to the side of contact between said magnetic element of said second part and said area for detecting and communicating data input of said first part.

35. A data input element for a portable electronic device according to claim 34, wherein said first part is stationary and said second part is movable.

36. A data input element for a portable electronic device according to claim 34, wherein said second part is connected to said first part by force of magnetic attraction.

37. A data input element for a portable electronic device according to claim 34, wherein said first part is connected to said portable electronic device by force of magnetic attraction.

38. A data input element for a portable electronic device according to claim 34, wherein location of said data input element on said portable electronic device may changed by a user.

39. A data input element for a portable electronic device according to claim 34, wherein said area for detecting and communicating data input is a conductive contact pad.

40. A data input element for a portable electronic device according to claim 34, wherein said area for detecting and communicating data input is a capacitive pad.

41. A data input element for a portable electronic device according to claim 34, wherein said magnetic element of said second part is annular in shape and said magnetic element of said first part is shaped as a parallelogram.

42. A data input element for a portable electronic device according to claim 34, wherein said magnetic element of said second part is annular in shape and said magnetic element of said first part is shaped as square.

43.-48. (canceled)

49. A data input element for a portable electronic device according to claim 34, wherein said area for detecting and communicating data input to said device includes at least one magnetic element.

50. A data input element for a portable electronic device according to claim 34, wherein at least one magnetic element is located under the surface of said portable electronic device at a location corresponding to the location of said area for detecting and communicating data input to said device.

51. A data input element for a portable electronic device according to claim 34, further comprising a an area for detecting and communicating data input to said device shaped as a circle and an area for detecting and communicating data input to said device shaped as a stripe.

52. A data input element for a portable electronic device according to claim 34, wherein said magnetic element of said first part is a magnet and said magnetic element of said second part is made from a ferromagnetic material.

53. A data input element for a portable electronic device according to claim 34, wherein said magnetic element of said first part is made from a ferromagnetic material and said magnetic element of said second part is a magnet.

54.-71. (canceled)
